(19) United States
(12) Patent Application Publication
(10) Pub. No.: US 2023/0018313 A1
(43) Pub. Date: Jan. 19, 2023

(54) METHOD FOR DETERMINING THE LEVEL OF UNUSUALNESS OF INDIVIDUALS, IN PARTICULAR IN ORDER TO STATISTICALLY DETECT UNUSUAL INDIVIDUALS IN A MULTIVARIATE CONTEXT

(71) Applicant: IPPON INNOVATION, TOULOUSE (FR)

(72) Inventors: Aurore ARCHIMBAUD, TOULOUSE (FR); Anne RUIZ, TOULOUSE (FR); Carole SOUAL, TOULOUSE (FR)

(21) Appl. No.: 17/784,615

(22) PCT Filed: Aug. 3, 2021
(86) PCT No.: PCT/EP2021/071671

§ 371 Date: Jun. 10, 2022

(30) Foreign Application Priority Data
Aug. 3, 2020 (FR) 2008243

(51) Int. Cl. G05B 19/406

(52) U.S. Cl. CPC G05B 19/406; G05B 2219/32368

(57) ABSTRACT

A method for determining the level of unusualness of individuals, in particular in order to statistically detect unusual individuals in a set of previously gathered data resulting from measurements of parameters of individuals taken by a plurality of measuring systems. The data is pre-processed, and a multivariate unusualness index is determined. The index being transformed by a function so as to be between 0 and 1, on the set of measurements for each individual based on the preprocessed data. Unusual individuals are then identified.

### TECHNICAL FIELD OF THE INVENTION

The present invention belongs to the field of quality control, such as that of electronic components or products from the pharmaceutical industry, for example vaccines. In particular, the invention relates to a method for determining the level of unusualness of individuals, allowing in particular statistically detecting unusual individuals in a multivariate context, i.e., the individuals are characterised by several tests or measurements.

In the present application, the term “individual” refers to any part or batch produced in small, medium or large series by industrial production means or others.

In particular, an unusual individual is an individual which has passed all tests successfully, but which is statistically unusual, and therefore, a potentially non-compliant individual. Indeed, experience on electronic components or vaccines shows that statistical unusualness, even on parts or batches that have successfully passed quality control tests, might reveal a latent quality or reliability problem.

### BACKGROUND OF THE INVENTION

Advantageously, the present invention could be applied to the semiconductor industry sector. This industry produces integrated circuits, called “electronic components”, which are manufactured on batches of silicon wafers, each wafer comprising several hundred electronic components.

In order to ensure the operation of these electronic components, series of tests are performed on each of the components while they are still part of a wafer.

One or two specification limit(s) are associated to each of these tests.

Electronic components whose response to at least one test does not comply with the specification of this test, i.e., whose response is outside the limits of said specification, are then considered to be defective, and are rejected upon separation thereof from the wafer.

This conventional quality control may be completed with statistical methods for detecting anomalies, for example in components intended for the automotive industry, to minimise quality problems perceived by the customer. The matter is then to eliminate good parts (which have passed all tests) because they are statistically abnormal and might sometimes turn out to be bad for the customer. This zero-defect objective uses so-called “univariate” or “bivariate” methods.

For example, a univariate method called Part Average Testing (PAT) compares the response of a test of an electronic component to the average distribution of the responses of this test of the other electronic components and considers as an unusual electronic component, an electronic component whose response is too far from the response distribution of the other electronic components.

In general, this method is not satisfactory in practice because it often leads to many false alarms since it is enough for a value to be more than k standard deviations far from the mean on just one of the p parameters for the individual to be considered as unusual. The more the number p of parameters increases, the more likely the individual would be unusual on at least one test.

By using these univariate (PAT, etc.) or bivariate (simple regressions between one test and another and detection of unusual individuals based on these regressions) methods on a very large number of tests, manufacturers therefore reject too many components, including many correct components, which deprives them of a few percent of their production, yet while not guaranteeing them the elimination of all potentially defective components.

Indeed, these methods are applied on each measurement of a test independently and therefore the rate of false alarms increases drastically with the number of measurements. In order to limit this number of false alarms (and therefore the cost related to detection), the statistical limits are often selected too permissively, with the risk of not being enough.

Hence, these methods present the risk of allowing electronic components with a latent defect that might become apparent during use of the part in the context of the customer's application, to be considered as reliable and deliverable to the customer.

This drawback is inconvenient, on the one hand, because it obliges the manufacturer to send a new replacement part to the customer should a latent defect be identified, and reduces its level of quality perceived by the customer, but, even more, because some of these components, although with a low unit cost, are critical components in the operation of a more complex system, for example an engine controller or an ABS braking system. In this case, a failure of the component might lead to a serious accident, the consequences of which go far beyond the simple financial value of the component.

Although already featuring a certain performance, these methods are therefore not enough to achieve zero defects.

Hence, solutions have been developed to meet this need with the implementation of multivariate statistical methods, in particular principal component analysis methods or Mahalanobis's distance and Hotelling's T².

Nonetheless, these solutions only partially meet the expectations of the industrial manufacturing context. Indeed, since principal component analysis methods are not specially designed to detect unusual individuals, they are often in difficulty to achieve such a task.

More specifically, Mahalanobis's distance and Hotelling's T² are multivariate distances of similarity of individuals which could therefore be used to identify unusual individuals. Nonetheless, these methods are in difficulty when the unusualness is due to only one subset and not to most of measurements, which is actually the practice in the industrial manufacturing context, given the high standards of desired quality.

There are other multivariate methods, such as the method known to a person skilled in the art by the English acronym “LOF”, standing for “local outlier factor”. Nonetheless, this method has several major drawbacks: there is no clear statistical rule for identifying unusual individuals, it requires an optimisation of a parameter intrinsic to the algorithm (the number of neighbours) and it requires a computing capacity even more considerable as the volume of data increases; which represents non-negligible constraints. In particular, given these drawbacks, real-time use on production lines is impossible.

In turn, some methods are based on knowledge of the defects to be detected, these are then called “supervised” methods, which obliges manufacturers to recalibrate the method for each new product and/or addition of tests in the test coverage improvement process.

Many methods are content to assign an unusualness indicator to each individual without actually identifying unusual individuals. Concretely, they sort out or classify the individuals from the most unusual to the least unusual but cannot ensure that the first individual is really unusual.

Finally, in general, the greatest limitation of these methods lies in the fact that they are generally no longer applicable when the number of measurements is greater than the number of individuals or when there is a correlation between the variables, which is common in an industrial or pharmaceutical context.

Indeed, the analysed data are often derived from a large number of measurements carried out by a certain number of tests, typically hundreds or even thousands, on each electronic component or individual.

### OBJECT AND SUMMARY OF THE INVENTION

An objective of the present invention is to overcome the aforementioned drawbacks.

To this end, the invention relates to a method for determining the level of unusualness of individuals, allowing in particular statistically detecting unusual individuals in a set of data previously gathered, derived from measurements of individual parameters carried out by a plurality of measuring systems.

Preferably, the individuals are electronic components.

The method includes the steps of:
pre-processing the data;
determining a multivariate unusualness index, said index being transformed by a function f so as to be comprised between 0 and 1, on all measurements for each individual, from the pre-processed data;
identifying the unusual individuals.

In particular embodiments, the invention also incorporates the following features, implemented separately or in any of their technically effective combinations.

In some implementations of the invention, the pre-processing step is carried out by a standardisation step in which for each measured parameter j, each individual x(i,j) is centred by the empirical average μⱼ of the set of values of the parameter j and we divide by the empirical standard deviation σⱼ.

In some implementations of the invention, the pre-processing step is carried out by a robust standardisation step implementing robust statistical indicators.

In some implementations of the invention, following the determination step, a step of identifying and selecting a subset of individuals whose unusualness index is zero is carried out.

In some implementations of the invention, during the step of determining a multivariate unusualness index, the deviations in absolute value from the mean on each variable p, for each electronic component i and for each difference greater than a reference value k are summed.

In some implementations of the invention, the following transformation is applied to the raw multivariate unusualness indices, with CD the distribution function of an inverse Gaussian law:

$${z}_{i} = Φ ( \frac{{index}_{i} - {μ}_{{index}_{i}}}{{σ}_{{index}_{i}}} ) \qquad [ Equation 1 ]$$

In some implementations of the invention, the step of determining a multivariate unusualness index includes a sub-step in which an unusualness index of individuals forming a subset called “reference subset” is determined, and a sub-step in which a multivariate unusualness index of a new individual is determined, the step of identifying unusual individuals being applied afterwards to the new individual with regards to the unusualness indices of the individuals of the reference subset, said new individual then being integrated into the reference subset if it is considered as non-unusual, and being rejected if it is considered as unusual.

In some implementations of the invention, the step of identifying unusual individuals includes sub-steps in which:
the determined unusualness indices zᵢ of the individuals are sorted in ascending order;
the deviation between two consecutive unusualness indices zᵢ is measured;
groups of individuals having statistically similar unusualness indices are determined, and
the unusual individuals, and more particularly the groups of individuals, are identified on the basis of a predefined maximum rate of acceptable unusual individuals.

In some implementations of the invention, during the step of identifying the unusual individuals, it is determined whether the group of individuals in which the individuals have the highest unusualness indices includes a number of individuals lower than a maximum threshold of acceptable unusual individuals predetermined as a function of the predefined maximum rate. If so is the case, it is proceeded with the determination of a set of groups including the first group and the next group(s) in a successive and decreasing order, such that the sum of the individuals of the groups of the set is lower than the predetermined threshold.

According to another aspect, the present invention also relates to a use of the method as described before, to detect batches of unusual vaccines in a sample of batches of vaccines. This means that the individuals are batches of vaccines.

According to another aspect, the present invention also relates to a use of the method as described before, to detect unusual electronic components in a sample of electronic components. This means that the individuals are electronic components.

According to another aspect, the present invention also relates to a use of the method as described before, to detect unusual measurements derived from data originating from sensors installed on production or measuring equipment.

Thus, in the present text, the term “individual” also extends to data representative of measurements.

These features advantageously allow the invention to be integrated into predictive maintenance applications, the unusualness of a measurement may be an indicator of a latent defect in the production or measuring equipment from which the data originate.

The invention also relates to a processor configured to:
pre-process previously gathered data on characteristics of the electronic components, derived from measurements of parameters of the electronic components carried out by a plurality of measuring systems,
determine a multivariate unusualness index, said index being transformed by a function f so as to be comprised between 0 and 1, on all measurements for each electronic component, from the pre-processed data;
identify unusual electronic components in a sample of electronic components.

Thus, this processor allows identifying unusual electronic components in a sample of electronic components.

The invention also relates to a computer program product comprising program code instructions which, when they are executed by one or several processor(s), configures the processor(s) to implement a previously-described method.

Advantageously, this computer program product enables a processor to identify unusual electronic components in a sample of electronic components.

### BRIEF DESCRIPTION OF THE FIGURES

The invention will be better understood upon reading the following description, provided as a non-limiting example, and made with reference to the figures which represent:

FIG. 1 is a flowchart representing the steps of the method according to the invention; and

FIG. 2 is a graph on which is represented a sample of individuals sorted in an increasing manner according to their unusualness index.

In these figures, identical reference numerals from one figure to another refer to identical or similar elements. Moreover, for clarity, the drawings are not to scale, unless stated otherwise.

### DESCRIPTION OF THE EMBODIMENTS

The present invention is implemented by computer software executed by a calculator, such as a processor, of a computer.

The method for determining the level of unusualness of individuals, allowing in particular statistically detecting unusual individuals according to the present invention, is applied on a set of data previously gathered and characterised by one or several measurement(s) carried out by measuring systems on a plurality of individuals.

In the present application, a measuring system may be an electrical tester, a biological measuring system, a physical measuring sensor or more generally any tool adapted to carry out a measurement.

For example, this data set may be organised in the form of a data table whose rows represent n individuals and whose columns represent p variables corresponding to the measurements performed on the individuals. The values of these measurements are numerical or binary.

Advantageously, the data set may contain a different number of measurements for each individual without this being detrimental to the proper operation of the method according to the invention. Furthermore, the number of measurements may be greater than or equal to the number of individuals, and conversely, the number of individuals may be greater than or equal to the number of measurements, without this impacting the operation of the method according to the invention.

The data set are derived from a sample of at least three individuals, the number of variables may be comprised between one and several thousand(s), the only limit being the computing power of the computer means with which the invention is intended to be implemented.

As an example of a non-limiting application, the individuals may be electronic components, batches of vaccines, etc. Preferably, the individuals are electronic components.

Furthermore, the measurements may be carried out on parameters or physical characteristics of individuals produced by means of an industrial production, for example at the end of production, in the context of a quality control of said individuals.

At the end of production, the quality control of electronic components comprises several steps. At first, a control operation, also called wafer testing, is carried out on a wafer grouping together several electronic components by means of microscopic needles. Equipment simulates the operation of the component and measures its physical characteristics and the parameters during operation. Said tests may be carried out under different environmental conditions, such as at cold, ambient or hot temperature.

Thus, for one component, the number of tests carried out may vary between ten and several thousands. A wafer may comprise a few hundred to several thousand electronic components.

Another control operation is usually carried out after the assembly phase, called final test.

The physical characteristics and the parameters may be currents, voltages, frequencies, delays but also accelerations or else luminosity.

The method aims to identify unusual electronic components during each of the control operations of said electronic components.

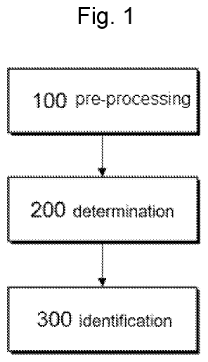

As shown in the flowchart of FIG. 1, the method includes the successive steps of:
pre-processing 100 the data;
determining 200 a multivariate unusualness index, said index being transformed by a function f so as to be comprised between 0 and 1, on all measurements for each individual;
identifying 300 the unusual individuals.

The data pre-processing allows obtaining data independent of their unit or measurement scale.

In the following text, we define x₁, . . . , xₙ, n observations characterised by p quantitative variables. More specifically, in the example of application of the method according to the invention, xᵢ represents all of the measurements carried out on the part i.

In this pre-processing step 100, we look to standardise initial data xᵢ, j in order to obtain new data yᵢ, j.

In an embodiment of the invention, the pre-processing step 100 may be carried out by a non-robust standardisation step which could be characterised as described hereinbelow.

For each measured parameter j, each individual xᵢ, j is centred by the empirical mean μⱼ; of all of the values of the parameter j and we divide by the empirical standard deviation σⱼ:

$${y}_{i , j} = \frac{{x}_{i , j} - {μ}_{j}}{{σ}_{j}} \qquad [ Equation 2 ]$$

In another embodiment of the invention, the pre-processing step 100 may be carried out by a robust standardisation step.

More specifically, the robust standardisation step may implement robust statistical indicators such as the median or the truncated mean as a position parameter, i.e., instead of the empirical mean μⱼ in the equation formulated hereinabove, and of the interquartile range or the absolute median deviation for the scale parameter, i.e., instead of the empirical standard deviation σⱼ in the equation formulated hereinabove.

Concretely, the non-robust standardisation step is preferred to the robust standardisation step in the presence of data that do not follow a Normal law or when the values of these data are very extreme. Indeed, non-robust estimators such as the mean are sensitive to the presence of extreme values, unlike the median.

Afterwards, the step 200 of determining a multivariate unusualness index is implemented on all measurements for each individual.

More specifically, in this step, one seeks to determine a raw multivariate unusualness index for each part or individual i from the pre-processed data y_{i,j}.

To this end, for each individual i, the deviations in absolute value from the mean on each variable p are summed, for any deviation greater than a reference value k, with k∈ [symbol] ⁺.

$${index}_{i} = {\sum }_{j = 1}^{p} \{ \begin{matrix}\vert {y}_{i , j} \vert - k , si \vert {y}_{i , j} \vert > k \\ 0 , otherwise\end{matrix} \qquad [ Equation 3 ]$$

Raw unusualness indices with values in [symbol] ⁺ undergo a transformation f which projects them between [0, 1]. Unusualness indices z; whose value is comprised between 0 and 1 are obtained, which makes them comparable with each other.

zᵢ=f(indexᵢ) [Equation 4]

Alternatively, to the previous transformation, it is possible to apply the following transformation to raw unusualness indices:

$${z}_{i} = Φ ( \frac{{index}_{i} - {μ}_{{index}_{i}}}{{σ}_{{index}_{i}}} ) \qquad [ Equation 5 ]$$

With Φ the distribution function of an inverse Gaussian law with a mean and a dispersion equal to 1.

Advantageously, the step 200 of determining a multivariate unusualness index allows creating an index that aggregates the univariate unusualnesses, even the low ones.

More particularly, the unusualness index allows identifying as potentially unusual individuals, on the one hand, weakly unusual in a univariate manner over a large number of parameters and, on the other hand, strongly unusual over one or a few parameters.

It should be noted that individuals whose unusualness index is zero do not have any unusualness, and that the more an individual has an unusualness index close to 1, the more likely it will be unusual.

It should herein be understood that an individual whose unusualness index is non-zero could be either non-unusual or unusual.

Hence, the present invention advantageously allows detecting individuals having no unusualness, to the extent that the unusualness index of an individual could be zero. If all individuals have a zero unusualness index, there is no unusual individual in the analysed sample of individuals.

Thus, following the determination step 200, it is possible to identify and select a subset of individuals that are certainly not unusual, by identifying and selecting the individuals whose unusualness index is zero.

This subset is herein called “reference subset”. This selection of the “best” individuals, best in the sense that they have no unusualness, is not just the symmetric of the procedure that consists in eliminating all unusual individuals because the latter statistically assesses unusualness the level while the selection of a reference subset goes further by eliminating individuals that have a little unusualness even though this is not statistically proven.

The selection of a reference subset is particularly advantageous, in particular because it allows isolating parts having no unusualness and using these parts. This is essential in some kinds of industry, for example, in the space industry or in large space programs, only parts that do not have any unusualness are sent into space.

To summarise, the method according to the invention allows identifying unusual individuals and individuals having no unusualness.

Furthermore, the multivariate unusualness index is computable even when there are more variables than observations, unlike most multivariate detection methods.

This specificity is particularly advantageous to the extent that too many variables in comparison with the number of observations could generate noise that might prevent or complicate the identification of unusual individuals.

Finally, these features advantageously allow applying the method to data sets including missing data.

The standardisation between 0 and 1 of the unusualness indices, upon completion of the step 200 of determining said indices, confers a major industrial advantage, in particular when the traceability of the parts is not ensured during their quality control after production.

Indeed, thanks to the method according to the invention, in a particular embodiment of the invention, the step 200 of determining a multivariate unusualness index includes a sub-step in which an unusualness index is determined for individuals forming a subset so-called “reference subset”, and a sub-step in which an unusualness index of a new individual is determined.

Afterwards, the step 300 of identifying unusual individuals is applied to the new individual with regards to the unusualness indices of the individuals of the reference subset.

Said new individual is then directly rejected if it is considered as unusual.

Alternatively, the step 200 of determining a multivariate unusualness index may include sub-steps in which the unusualness index of individuals forming the reference subset is determined, then limits of unusualness indices of said reference subset are determined on the basis of the unusualness indices of its individuals. For example, these limits are defined according to the standard deviation of the reference subset, of the type μ±kσ with k=3 for example, μ and σ being determined according to the values of the reference subset.

Afterwards, analogously to what has been previously described, a sub-step of determining an unusualness index of a new individual is carried out.

Thus, it is possible to achieve a turnover of the “first in, first out” type, known to a person skilled in the art by the acronym “FIFO” standing for “first in first out”.

Consequently, it is possible to eliminate any unusual part in an integrated manner in the industrial production process, continuously.

These dynamic modes of implementations of the invention are particularly advantageous in the cases where, during production, the traceability of the produced individuals is not physically ensured, and that the unusual individuals detected with conventional methods for detecting unusual individuals, so-called “post-processing”, cannot be put off.

The post-processing methods consist in statistically identifying the unusual individuals from a sample of individuals, then physically identifying the unusual individuals to eliminate them. Hence, this requires the traceability of each produced individual and processing a sample of individuals. The present invention suppresses this constraint and allows eliminating individuals on the fly.

It should be noted that thanks to the standardisation of the unusualness indices, that of the observed new individual is comparable to that of the other individuals, even when it originates from a new batch, which is not necessarily the case with known statistical detection methods.

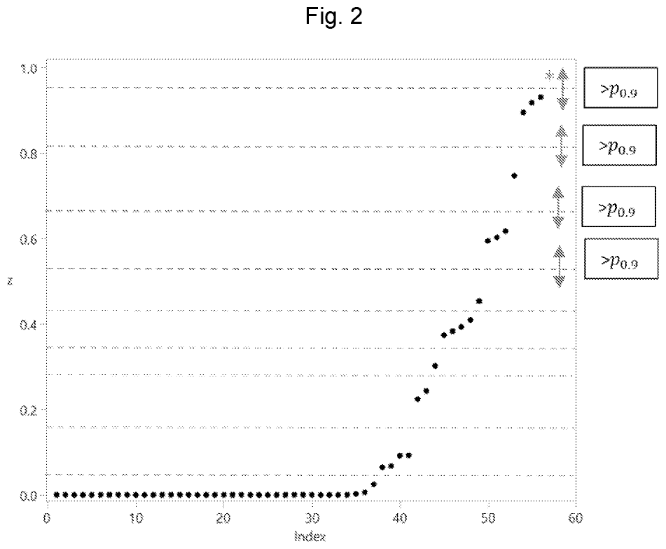

The step 300 of identifying the unusual individuals may preferably consist in implementing the following sub-steps:
sort out the determined unusualness indices z; of the individuals in ascending order, as shown in the graph of FIG. 2, i.e.:

z₍₁₎≥ . . . ≥z₍ₙ₎ [Equation 6]
measure the deviation between two consecutive unusualness indices zᵢ:

wᵢ=z₍ᵢ₎−z₍ᵢ₋₁₎ [Equation 7]

These differences wᵢ follow the following distribution law:

F(w)=1−(1−w)^{m} with a mean [Equation 8]

$$\frac{1}{n + 1} . \qquad [ Equation 9 ]$$

identify the individuals that are unusual compared to all individuals.

This last sub-step is carried out by identifying groups of individuals with statistically similar unusualness indices. This identification is carried out according to the deviations between two successive unusualness indices.

In the graph of FIG. 2, the groups of individuals are separated by horizontal dashed lines.

More specifically, the deviations between two successive unusualness indices greater than the a-th percentile are identified:

$$v ( α ) = 1 - {( 1 - α )}^{\frac{1}{n}} \qquad [ Equation 10 ]$$

In the embodiment represented in FIG. 2, the selected percentile value is α=90%.

These deviations are calculated, because theoretically the differences of the deviations follow the distribution law previously described in [Math.7], and the method could be based on a theoretical threshold to identify groups of individuals.

Thus, a comparison between individuals is advantageously carried out so that if an individual is statistically unusual but not significantly more than the other individuals then it is not identified as unusual.

Thanks to this identification operation, groups of individuals with a substantially similar or analogous level of unusualness are determined. In this manner, all of the individuals forming a group are identified as unusual or as non-unusual. Thus, the reliability of the detection of unusual individuals is considerably increased to the extent that the method guarantees that two individuals having a very close unusualness index are both identified as unusual or as non-unusual. And it is therefore possible to go beyond the detection of unusual individuals, since it is thus possible to generate a subset of individuals with homogeneous unusualness indices.

Advantageously, the approach of the method of the present invention is thus to identify groups of unusual individuals.

The groups of individuals with a substantially similar or analogous level of unusualness being determined and the determined unusualness indices z; of the individuals being sorted in increasing order, the groups are, actually, sorted in increasing order according to the level of unusualness of their respective individuals, as shown in FIG. 2.

The next step of the method is the identification of the groups of unusual individuals according to a predetermined maximum rate of acceptable unusual individuals.

In the embodiment represented in FIG. 2, the maximum rate of acceptable unusual individuals is 10%. The graph representing 57 individuals, the maximum threshold of acceptable unusual individuals is 5.

More specifically, during this step, it is determined whether the group of individuals in which the individuals have the highest unusualness indices, called the “first group”, includes a number of individuals less than or equal to the predetermined maximum threshold of acceptable unusual individuals.

If so is the case, then all of the individuals of that group are identified as unusual, otherwise they are considered as non-unusual.

In the case where the individuals of the first group are identified as unusual, it is proceeded with the identification of the group whose individual(s) has/have immediately lower unusualness indices and each of the next groups, successively, as long as the sum of the individuals of said group or of all of said groups is less than or equal to the maximum threshold, the individuals of said identified group(s) then being identified as unusual.

In other words, if the individuals of the first group are identified as unusual, one seeks to know whether those of the group in which the individuals have unusualness indices immediately lower than those of the first group, called “second group”, are unusual too.

In the example represented in FIG. 2, the first group includes a unique individual, the search for unusual individuals is therefore extended to the next group, i.e., to the second group.

Afterwards, the number of individuals in the first and second groups is then added.

If the sum of the individuals of the first and second groups is less than or equal to the maximum threshold, then all of the individuals of the second group are also identified as unusual, otherwise they are considered as non-unusual.

In the example represented in FIG. 2, the second group including three individuals, the sum of individuals of the first and second groups is equal to four, the search for unusual individuals is extended to the next group, i.e. to the third group. The individuals of the first and second group are considered as unusual.

These operations are iterated until identifying a group whose individuals are not unusual is identified, i.e., until the sum of the individuals of the studied groups is greater than the maximum threshold. From this group, all next groups, i.e., the groups having individuals whose unusualness indices are lower than those of the studied groups, therefore consist of non-unusual individuals.

In the example represented in FIG. 2, as the third group includes a unique individual, the sum of the individuals of the first to third groups is equal to five.

The individuals of the first to third groups are considered as unusual, the individuals of the other groups being considered as non-unusual.

Advantageously, thanks to these operations, the rate of false alarms, i.e. of error in the identifications of unusual individuals, is substantially reduced, and that being so, without the need for imposing a strict rate of unusual individuals to be met.

Once detected, the unusual individuals could finally be identified thanks to physical traceability, or else be eliminated directly thanks to the dynamic mode of implementation.

Alternatively, in another mode of implementation of the method according to the invention, the step 300 of identifying the unusual individuals may consist in applying a statistical method on the unusualness index to detect unusual individuals.

For example, it is possible to calculate a limit of the type μ±kσ with k=3 for example, μ and σ being determined according to the values of the sample. These unusual individuals are then eliminated from the production, if the production process of the individuals allows the traceability of the produced individuals.

The present invention then allows returning to a univariate case to the extent that there is only one unusualness index per individual, but by eliminating or considerably limiting false alarms in comparison with the statistical detection methods of the prior art.

An example of a processor is now described. Said processor is configured to:
pre-process data previously gathered on characteristics of the electronic components, derived from measurements of parameters of the electronic components carried out by a plurality of measuring systems,
determine a multivariate unusualness index, said index being transformed by a function f so as to be comprised between 0 and 1, on all measurements for each electronic component, from the pre-processed data,
identify unusual electronic components in a sample of electronic components.

The processor may contain several calculation cores, and have a clock frequency of several gigahertz.

The processor may be integrated into a computer and connected to a compatible motherboard.

Also, several processors may be architectured so as to process all of the calculations necessary for carrying out the different steps, in parallel. This allows increasing the computing power, therefore accelerating the completion of the different steps, being able to process more data and limiting the overheating of the processors.

An example of a computer program product is now described. Said program product comprises program code instructions which, when they are executed by one or several processor(s), configure the processor(s) to implement any of the methods in any mode. Said program code instructions may be coded in the Python or C++ language for example.

More generally, it should be noted that the implementations and embodiments of the invention considered hereinabove have been described as non-limiting examples and that other variants could consequently be considered.

1-11. (canceled)

12. A method for identifying unusual electronic components in a sample of electronic components, implemented by a processor-based computer, comprising:
statistically detecting the unusual electronic components in a set of previously gathered data on parameters or physical characteristics of the electronic components, derived from measurements of parameters or of the physical characteristics of the electronic components performed by a plurality of measuring systems;
pre-processing the data to provide pre-processed data;
determining a multivariate unusualness index from the pre-processed data, the multivariate unusualness index being transformed by a function so as to be between 0 and 1, on all measurements for each electronic component; and
identifying the unusual electronic components.

13. The method of claim 12, wherein the pre-processing step is performed by a standardization step in which for each measured parameter j, each electronic component x(i,j) is centered by the empirical average μⱼ of a set of values of said each measured parameter j and divided by an empirical standard deviation σⱼ.

14. The method of claim 12, wherein the pre-processing step is performed by a robust standardization step implementing robust statistical indicators.

15. The method of claim 12, further comprising, subsequent to the determining step, identifying and selecting a subset of the electronic components whose multivariate unusualness index is zero.

16. The method of claim 12, wherein deviations in an absolute value from a mean on each variable p, for said each electronic component i and for each difference greater than a reference value k are summed to determine a raw multivariate unusualness index.

17. The method of claim 16, further comprising applying the following transformation to the raw multivariate unusualness indices, with (D the distribution function of an inverse Gaussian law:
$${z}_{i} = Φ ( \frac{{index}_{i} - {μ}_{{index}_{i}}}{{σ}_{{index}_{i}}} ) .$$

18. The method of claim 12, wherein the step of determining the multivariate unusualness index further comprises determining a reference subset from an unusualness index of electronic components and determining a multivariate unusualness index of a new electronic component; wherein the identifying step is applied afterwards to the new electronic component with regards to the unusualness indices of the electronic components of the reference subset, the new electronic component then being integrated into the reference subset if the new electronic component is considered as a non-unusual, and being rejected if the new electronic component is considered as unusual.

19. The method of claim 12, wherein the identifying step further comprises:
sorting the multivariate unusualness indices zᵢ of the electronic components in an ascending order;
measuring a deviation between two consecutive unusualness indices zᵢ;
determining groups of electronic components having statistically similar unusualness indices; and
identifying the unusual electronic components based on a predefined maximum rate of acceptable unusual electronic components.

20. The method of claim 19, further comprising (a) determining whether a group of electronic components having a highest unusualness indices includes a number of electronic components lower than a maximum threshold of acceptable unusual electronic components, the maximum threshold being predetermined as a function of a predefined maximum rate; and repeating, in response to a determination that the number of electronic components in the group of electronic components is lower than the maximum threshold, the step (a) for another group of electronic components, in a successive and decreasing order, until a sum of the electronic components of the groups is lower than the maximum threshold to determine a set of groups.

21. A processor configured to:
pre-process previously gathered data on characteristics of electronic components, derived from measurements of parameters of the electronic components performed by a plurality of measuring systems;
determine a multivariate unusualness index from the pre-processed data, the multivariate unusualness index being transformed by a function so as to be between 0 and 1, on all measurements for each electronic component; and
identify unusual electronic components in a sample of the electronic components.

22. A computer program product comprising program code instructions, when executed by at least one processor, configures said at least one processor to implement a method of claim 12.

23. A computer memory storing the computer program product of claim 22.
